(19) United States
(12) Patent Application Publication
(10) Pub. No.: US 2022/0224177 A1
(43) Pub. Date: Jul. 14, 2022

(54) OIL-COOLING STRUCTURE FOR MAGNETS OF MOTOR, AND MOTOR

(71) Applicant: TOYOTA JIDOSHA KABUSHIKI KAISHA, Aichi-ken (JP)

(72) Inventor: Hironobu SAKAMOTO, Okazaki-shi (JP)

(21) Appl. No.: 17/549,866

(22) Filed: Dec. 14, 2021

(30) Foreign Application Priority Data
Jan. 8, 2021 (JP) 2021-002214

(51) Int. Cl. H02K 1/32; H02K 9/19

(52) U.S. Cl. CPC H02K 1/32; H02K 9/19

(57) ABSTRACT

An oil-cooling structure for motor magnets, that includes: a plurality of rectangular magnets arranged and aligned along an axial direction of a rotor shaft at interiors of holes for magnet placement that are formed in a rotor core and extend in the axial direction; a pair of expanding materials that are disposed between the holes and a pair of first surfaces, which extend in the axial direction, of the magnets disposed in the holes; a pair of holding frames that are disposed along the axial direction of the hole, adjacent to a pair of second surfaces, which extend in the axial direction of the rotor shaft, of the magnet; and grooves formed in the holding frames, recessed toward the side of the magnets at central regions in directions normal to the first surfaces at the holding frames, and extending in the axial direction.

### CROSS-REFERENCE TO RELATED APPLICATION

This application is based on and claims priority under 35 USC 119 from Japanese Patent Application No. 2021-002214 filed on Jan. 8, 2021, the disclosure of which is incorporated by reference herein.

### BACKGROUND

### Technical Field

The present disclosure relates to an oil-cooling structure for magnets of a motor, and to a motor.

### Related Art

Because there is the need to increase the rotational speeds of motors, improvements in the electromagnetic densities of motors have been devised. Due thereto, there is the concern that the magnets that are provided at a rotor will become high temperature, and the performances of the motor will deteriorate. Thus, improvements in the performance of cooling magnets have been devised.

Japanese Patent Application Laid-Open (JP-A) No. 2016-158365 discloses a structure having first oil flow paths that reach reverse surfaces of magnets disposed at an outer peripheral portion of a rotor core from an oil reservoir that is formed at the inner peripheral portion of the rotor core along the entire periphery thereof, and second oil flow paths that extend in the axial direction of the shaft along the reverse surfaces of the magnets. This structure cools the magnets efficiently by causing oil to flow along the reverse surfaces of the magnets.

By the way, in case in which the axial direction length of the rotor core of the motor is long, plural magnets are disposed at the rotor core so as to be lined-up in the axial direction. In this case, magnetic flux is generated between the magnets that are adjacent to one another, and the temperatures of the magnets increase even more. Therefore, an even further improvement in the cooling performance is required.

In a structure in which oil paths are provided at the inner peripheral surface sides of the magnets within the rotor core as in JP-A No. 2016-158365, if plural magnets are disposed so as to be lined-up, there is the concern that positional offset of the magnets will arise due to high speed rotation of the motor (the rotor core). Namely, there is room for improvement in the ability to hold the magnets at the time when the motor rotates.

### SUMMARY

An aspect is an oil-cooling structure for motor magnets, that includes: a rotor shaft; a rotor core mounted at an outer peripheral surface of the rotor shaft, which rotates integrally with the rotor shaft; a plurality of rectangular magnets arranged and aligned along an axial direction of the rotor shaft at interiors of holes for magnet placement that are formed in the rotor core and extend in the axial direction; a pair of expanding materials that are disposed between the holes and a pair of first surfaces, which extend in the axial direction, of the magnets disposed in the holes; a pair of holding frames that are disposed along the axial direction of the hole, adjacent to a pair of second surfaces, which extend in the axial direction of the rotor shaft, of the magnet; an oil reservoir formed at an interior of the rotor shaft, to which oil is supplied from an exterior; a pair of cooling oil paths that extend in the axial direction along sides, which are opposite from a side of the magnets, of the holding frames; radial direction oil paths formed so as to extend from the oil reservoir toward radial direction outer sides, and communicating the oil reservoir with the cooling oil paths; and grooves formed in the holding frames, recessed toward the side of the magnets at central regions in directions normal to the first surfaces at the holding frames, and extending in the axial direction.

### BRIEF DESCRIPTION OF THE DRAWINGS

FIG. 1 is a drawing showing a radial direction cross-section of a rotor of a motor relating to a first embodiment.

FIG. 2 is a radial direction cross-sectional view showing a magnet placement structure with respect to a hole that is formed in a rotor core relating to the first embodiment.

FIG. 3 is an axial direction cross-sectional view showing the magnet placement structure within the hole that is formed in the rotor core relating to the first embodiment.

FIG. 4 is a perspective view showing the arrangement of magnets, expanding materials, and holding frames that are disposed within the hole, relating to the first embodiment.

FIG. 5 is a perspective view showing a magnet that is disposed within the hole relating to the first embodiment.

FIG. 6 is a drawing showing a radial direction cross-section of a rotor of a motor relating to a second embodiment.

FIG. 7 is a drawing showing an axial direction cross-section of the rotor of the motor relating to the second embodiment.

FIG. 8 is a perspective view showing the arrangement of the magnets, expanding materials, and holding frames that are disposed within the hole, relating to the second embodiment.

FIG. 9 is a radial direction cross-sectional view showing a magnet placement structure with respect to the hole that is formed in the rotor core relating to the second embodiment.

### DETAILED DESCRIPTION

### First Embodiment

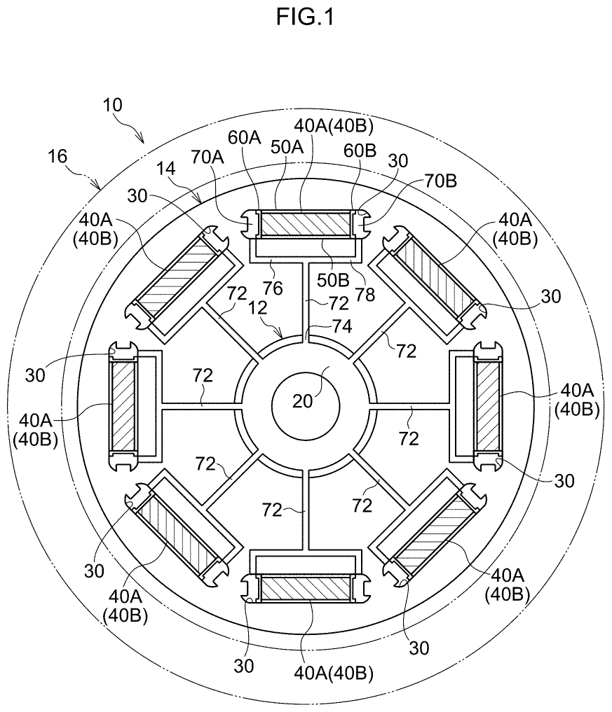

A motor that includes an oil-cooling structure for magnets of a motor relating to a first embodiment is described with reference to FIG. 1 through FIG. 5. Note that, in FIG. 1, in order to avoid complicating the drawing, cross-sectional hatching is omitted except for at the magnets, and only some of the reference numerals are shown whereas others are omitted. Further, the respective drawings are schematic illustrations, and the proportions differ from actual proportions.

(Structure)

First, a motor 10 to which the oil-cooling structure of the present embodiment is applied is described. Note that, at the magnet that is disposed in a hole 30 that is described later, the axial direction is shown as the arrow Z direction, the extending direction of a wide surface that is a direction orthogonal to the axial direction (i.e., the normal direction of the narrow surface) is the width (left-right) direction and is shown as the arrow X direction, and the extending direction of a narrow surface that is a direction orthogonal to the axial direction (i.e., the normal direction of the wide surface) is the vertical direction (the radial direction) and is shown as the arrow Y direction.

As shown in FIG. 1, the motor 10 has a rotor shaft 12, a rotor core 14 and a stator 16.

The rotor shaft 12 is solid cylindrical, and an oil reservoir 20 that is annular and extends in the axial direction is formed at the interior of the rotor shaft 12. Oil for cooling (hereinafter called “oil”) is supplied to the oil reservoir 20 from a supply source that is at an axial direction end portion.

The rotor core 14 is fit-together with the outer peripheral surface of the rotor shaft 12, and can rotate integrally with the rotor shaft 12.

The eight holes 30 for the placement of magnets (hereinafter called “holes 30”) are formed in the radial direction outer side of the rotor core 14 at a uniform interval in the peripheral direction. Each hole 30 extends in the axial direction from an axial direction one end portion to the other end portion of the rotor core 14.

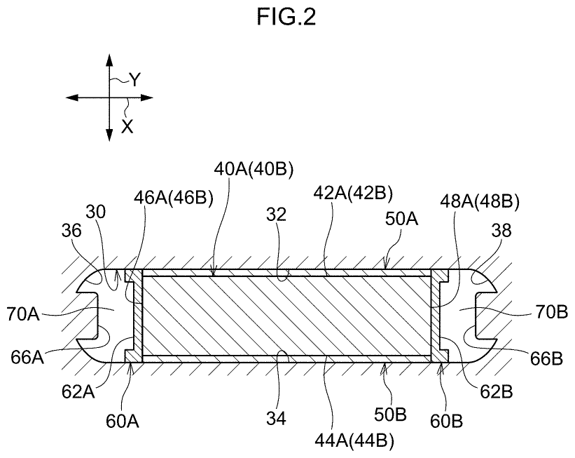

As shown in FIG. 2, the hole 30 is formed in a substantially rectangular shape as seen from the axial direction, and has a radial direction outer side surface 32 (hereinafter called “upper surface 32”), a radial direction inner side surface 34 (hereinafter called “lower surface 34”), an peripheral direction side surfaces 36, 38 (hereinafter called “left surface 36” and “right surface 38”, respectively).

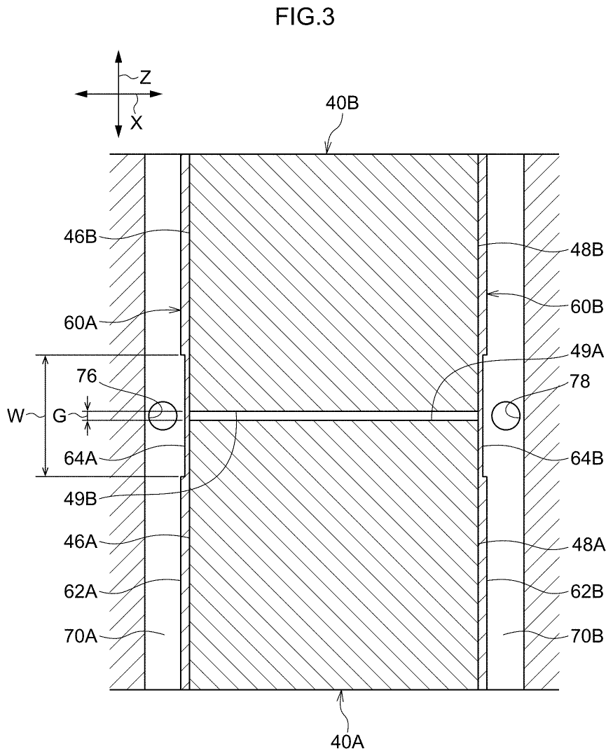

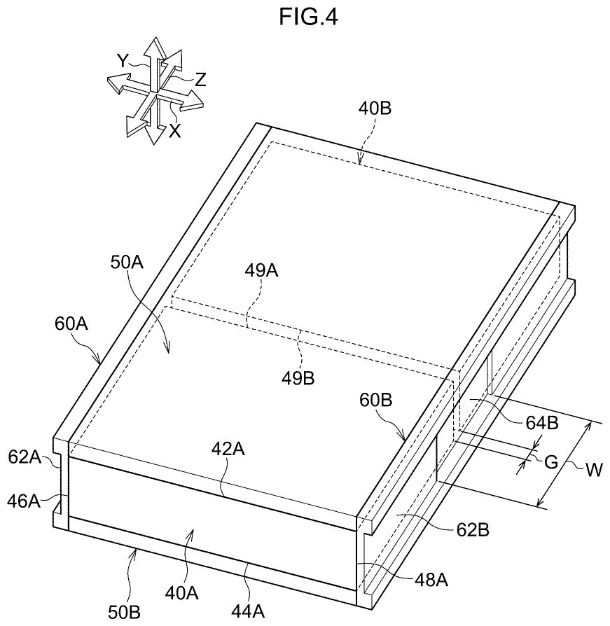

As shown in FIG. 3 and FIG. 4, two magnets 40A, 40B are disposed in the hole 30 so as to be lined-up in the axial direction.

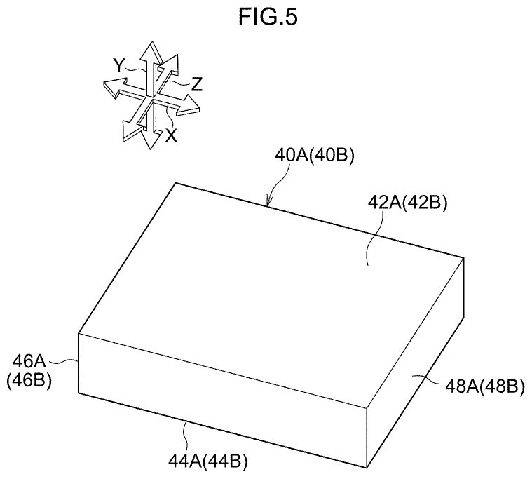

As shown in FIG. 5, the magnet 40A is rectangular and is disposed so as to be inserted in the hole 30 such that the arrow Z direction is the axial direction. Namely, as shown in FIG. 2, in the state in which the magnet 40A is inserted in the hole 30, the magnet 40A is disposed such that wide surfaces 42A, 44A face the upper surface 32, the lower surface 34 of the hole 30 respectively, and such that narrow surfaces 46A, 48A face the left surface 36, the right surface 38 of the hole 30 respectively.

Note that the “wide surface” corresponds to a first surface, and is the surface whose one sides are sides extending in the axial direction and whose another sides are sides orthogonal to the axial direction. The wide surface is the surface at which the length of the sides that are orthogonal to the axial direction is longer than that of (i.e., is the surface whose surface area is larger than that of) the “narrow surface” that corresponds to a second surface and that is formed similarly.

Further, because the magnet 40B has the same shape, the same structural elements are denoted by the same reference numerals but with the letter B appended thereto, and description thereof is omitted (see FIG. 5).

In order to stably hold the magnets 40A, 40B within the holes 30, as shown in FIG. 2 and FIG. 4, an expanding material 50A that is shaped as a thin plate is disposed between the upper surface of the hole 30 and the wide surface 42A, 42B of the magnet 40A, 40B. Further, an expanding material 50B that is shaped as a thin plate is disposed between the lower surface 34 of the hole 30 and the wide surface 44A, 44B of the magnet 40A, 40B. The expanding materials 50A, 50B extend within the hole 30 from an axial direction one end portion to the other end portion. Namely, as shown in FIG. 4, the expanding material 50A is a structure that covers the wide surfaces 42A, 42B of the magnets 40A, 40B, and the expanding material 50B is a structure that covers the wide surfaces 44A, 44B of the magnets 40A, 40B.

Note that the expanding materials 50A, 50B correspond to the “expanding material”.

Accordingly, by placing the expanding material 50A between the wide surfaces 42A, 42B of the magnets 40A, 40B and the upper surface 32 of the hole 30, and placing the expanding material 50B between the wide surfaces 44A, 44B and the lower surface 34 of the hole 30, as time passes, the expanding materials 50A, 50B expand and nip the magnets 40A, 40B within the hole 30.

Further, as shown in FIG. 2 and FIG. 4, a holding frame 60A that is made of resin is disposed within the hole 30 so as to be adjacent to the narrow surfaces 46A, 46B of the magnets 40A, 40B, and a holding frame 60B that is made of resin is disposed within the hole 30 so as to be adjacent to the narrow surfaces 48A, 48B. Note that, because the holding frames 60A, 60B are similar structures having left-right symmetry, only the holding frame 60A is described, and description of the holding frame 60B is omitted.

The holding frames 60A, 60B correspond to the “holding frames”.

The holding frame 60A is a height that reaches from the upper surface 32 to the lower surface 34 of the hole 30, and extends from an axial direction one end portion to the other end portion of the hole 30.

Note that the side surface, at the magnet 40A, 40B side of the holding frame 60A abuts the end surfaces of the expanding materials 50A, 50B and the narrow surfaces 46A, 46B of the magnets 40A, 40B.

A groove 62A, whose vertical direction central portion is recessed toward the magnet 40A, 40B side, is formed in the side surface of the holding frame 60A which side surface is at the side opposite the magnets 40A, 40B. The groove 62A is formed so as to pass-through from an axial direction one end portion to another end portion of the holding frame 60A.

Moreover, as shown in FIG. 3, at the groove 62A of the holding frame 60A, a concave portion 64A that is recessed further toward the magnet side is formed in the axial direction center (axial direction range W). Here, as shown in FIG. 3 and FIG. 4, the “axial direction range” (refer to arrow W in FIG. 3) is the range in the axial direction that includes gap G that is formed by axial direction end surfaces 49A, 49B that face the magnet 40A, 40B that is disposed adjacent thereto in the axial direction.

As shown in FIG. 2, convex portions 66A, 66B, which project-out toward the magnet 40A, 40B side with respect to the respective grooves 62A, 62B, are formed at the left surface 36 and the right surface 38 of the hole 30. The convex portions 66A, 66B also extend from an axial direction one end portion to another end portion of the hole 30.

As shown in FIG. 1 through FIG. 3, within the hole 30, the region between the left surface 36 of the hole 30 and the holding frame 60A, and the region between the right surface 38 of the hole 30 and the holding frame 60B, are structured as second oil paths 70A, 70B that are described later.

Note that the “second oil paths 70A, 70B” correspond to the “cooling oil paths”.

As shown in FIG. 1, third oil paths 72, which extend toward radial direction outer sides in a radial form from the rotor shaft 12 and branch-off to the left and right in the peripheral direction in vicinities of the magnets 40A, 40B and reach the second oil paths 70A, 70B, are formed in the rotor core 14.

Note that the “third oil paths 72” correspond to the “radial direction oil paths”.

At the radial direction inner side end portions thereof, the third oil paths 72 communicate with the oil reservoir 20 via holes 74 that are formed in the outer peripheral wall of the rotor shaft 12. Further, oil paths 76, 78 that branch-off from the third oil paths 72 communicate with the axial direction centers of the second oil paths 70A, 70B, respectively (see FIG. 3).

(Operation)

First, because the expanding materials 50A are disposed between the wide surfaces 42A, 42B of the magnets 40A, 40B and the upper surfaces 32 of the holes 30, and because the expanding materials 50B are disposed between the wide surfaces 44A, 44B and the lower surfaces 34 of the holes 30, the magnets 40A, 40B are nipped-in within the holes 30 by the expanding materials 50A, 50B due to the expansion of the expanding materials 50A, 50B over time. Accordingly, even if centrifugal force acts on the magnets 40A, 40B due to high speed rotation of the rotor core 14, offset of the magnets 40A, 40B within the holes 30 is prevented or suppressed.

Further, the holding frames 60A, 60B, which abut the narrow surfaces 46A, 46B, 48A, 48B of the magnets 40A, 40B and extend from the upper surfaces 32 to the lower surfaces 34 of the holes 30, are provided. These holding frames 60A, 60B extend from axial direction one end portions to other end portions of the holes 30 respectively, and support the narrow surfaces 46A, 46B, 48A, 48B of the magnets 40A, 40B. Namely, offset of the magnets 40A, 40B in the width direction within the holes 30 due to high speed rotation of the rotor core 14 is prevented or suppressed.

In this way, the upper and lower sides of the magnets 40A, 40B, which are disposed so as to be lined-up in the axial direction within the holes 30, are held by the expanding materials 50A, 50B, and the left and right sides of the magnets 40A, 40B are held by the holding frames 60A, 60B. Due thereto, even if the rotor core 14 rotates at high speed, the magnets 40A, 40B do not become offset within the holes 30, and are held reliably.

On the other hand, at the hole 30, the pairs of second oil paths 70A, 70B are formed at the sides of the holding frames 60A, 60B which sides are opposite the sides at which the magnets 40A, 40B are located. Oil is supplied from the oil reservoir 20 of the rotor shaft 12 via the third oil paths 72 to the second oil paths 70A, 70B due to centrifugal force.

The second oil paths 70A, 70B face the narrow surfaces 46A, 46B, 48A, 48B of the magnets 40A, 40B with the holding frames 60A, 60B disposed therebetween. Therefore, the second oil paths 70A, 70B can efficiently cool the magnets 40A, 40B.

In particular, because the grooves 62A, 62B, which are recessed toward the magnet side at the central regions in the vertical direction, are formed at the sides of the holding frames 60A, 60B which sides are opposite the magnets, oil is guided at the vertical direction central portions at the holding frames 60A, 60B. As a result, the vertical direction centers, at which heat becomes confined relatively at the magnets 40A, 40B, are cooled efficiently. Namely, the cooling performance of the motor 10 improves.

Note that the convex portions 66A, 66B, which face the grooves 62A, 62B and project-out toward the magnet 40A, 40B side, are formed in the left surfaces 36 and the right surfaces 38 of the holes 30 that structure the second oil paths 70A, 70B. Accordingly, even in cases in which there is the concern that oil will tend toward one side within the second oil paths 70A, 70B due to rotation of the rotor core 14, the oil can be reliably guided within the grooves 62A, 62B by the convex portions 66A, 66B, and the cooling performance can be improved more.

Further, the concave portions 64A, 64B that are recessed further toward the magnet 40A, 40B sides than the grooves 62A, 62B are formed in the axial direction centers (axial direction range W) of the grooves 62A, 62B of the holding frames 60A, 60B. Accordingly, the oil that is guided by the grooves 62A, 62B is guided by the concave portions 64A, 64B, and is stored.

The axial direction end surface 49A, 49B side portions (hereinafter called “axial direction end portions” upon occasion) of the magnets 40A, 40B that are lined-up in the axial direction within the holes 30 are included in the axial direction ranges W of the holes 30. Namely, these are the regions that are heated the most at the respective magnets 40A, 40B by the magnetic flux that is generated between the magnets 40A, 40B.

The concave portions 64A, 64B that are concave toward the magnet 40A, 40B side respectively are formed in the grooves 62A, 62B of the holding frames 60A, 60B that face the axial direction end portions of the magnets 40A, 40B, and oil is stored therein. Therefore, these regions are cooled the most.

Namely, the axial direction end portions, which face one another and where the temperatures are the highest at the respective magnets 40A, 40B due to the plural magnets 40A, 40B being disposed in the one hole 30, can be cooled the most. Due thereto, the temperatures of the respective magnets 40A, 40B can be made to be even more uniform. Namely, the performance of cooling the motor 10 can be improved.

(Effects)

In this way, at the motor 10, there is a structure in which the four surfaces of the rectangular magnets 40A, 40B are held within the holes 30 by the expanding materials 50A, 50B and the holding frames 60A, 60B. Therefore, even if the rotor core 14 rotates at high speed, the magnets 40A, 40B becoming offset within the holes 30 is prevented or suppressed.

On the other hand, the narrow surfaces 46A, 46B, 48A, 48B of the magnets 40A, 40B are cooled efficiently by the oil that flows through the second oil paths 70A, 70B that are formed such that the holding frames 60A, 60B are disposed between the narrow surfaces 46A, 46B, 48A, 48B and the second oil paths 70A, 70B. In particular, the oil is guided toward the vertical direction central regions by the grooves 62A, 62B that are formed in the holding frames 60A, 60B, and efficiently cools the magnets 40A, 40B, and the oil is stored in the concave portions 64A, 64B that are formed at the axial direction centers of the grooves 62A, 62B (the axial direction range W). Due thereto, the axial direction end portions that face one another of the magnets 40A, 40B which become the hottest can be cooled.

Namely, the performance of cooling the magnets 40A, 40B can be improved while the ability to hold the magnets 40A, 40B at the motor 10 is ensured.

### Second Embodiment

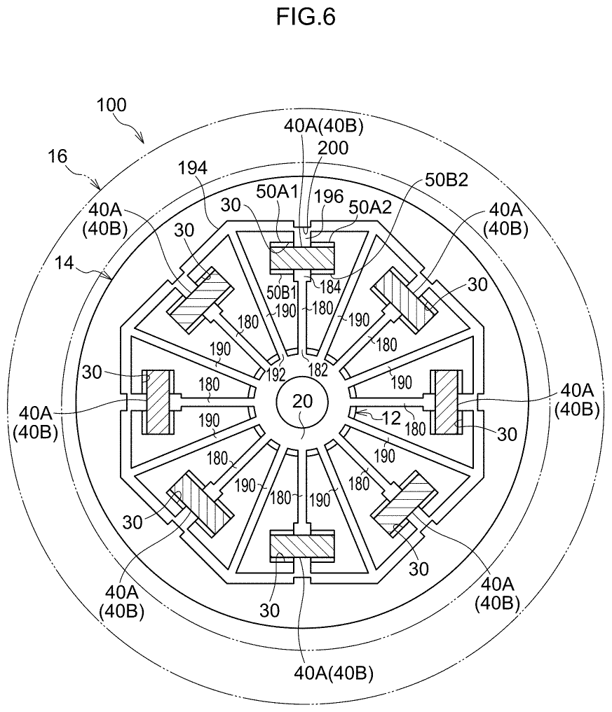

A motor that includes an oil-cooling structure for magnets of a motor relating to a second embodiment of the present disclosure is described with reference to FIG. 6 through FIG. 9. Structural elements that are similar to those of the first embodiment are denoted by the same reference numerals, and detailed description thereof is omitted. Note that, in FIG. 6, in order to avoid complicating the drawing, cross-sectional hatching is omitted except for at the magnets, and only some of the reference numerals are shown whereas others are omitted.

At a motor 100, the fact that the rectangular magnets 40A, 40B are lined-up along the axial direction within the holes 30 of the rotor core 14 is the same as in the first embodiment.

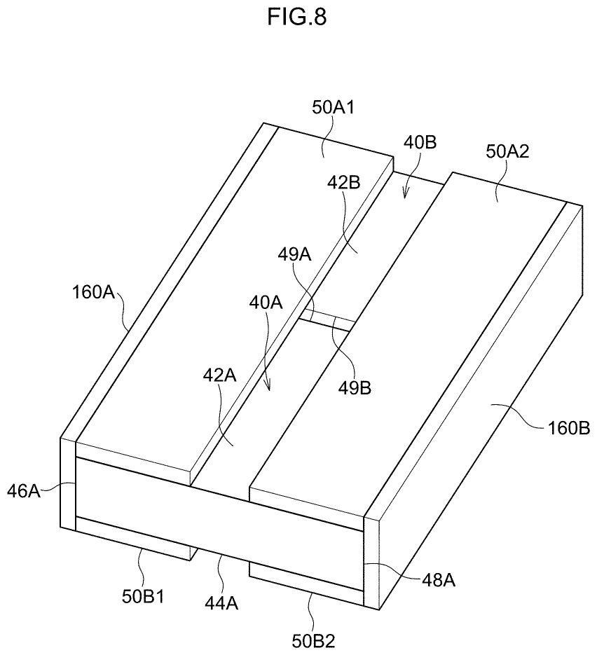

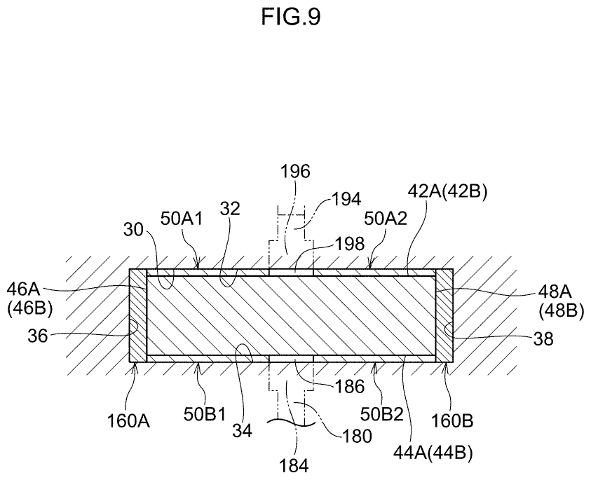

However, as shown in FIG. 8 and FIG. 9, the expanding material, which is disposed between the wide surfaces 42A, 42B of the magnets 40A, 40B and the upper surface 32 of the hole 30, is divided into two expanding materials 50A1, 50A2. The widths of the expanding materials 50A1, 50A2 are shorter than half of the width of the wide surfaces 42A, 42B of the magnets 40A, 40B, and therefore, the wide surfaces 42A, 42B of the magnets 40A, 40B are exposed from between the expanding materials 50A1, 50A2.

Note that, as shown in FIG. 9, the region between the upper surface 32 of the hole 30 and the wide surfaces 42A, 42B of the magnets 40A, 40B that is exposed from between the expanding materials 50A1, 50A2 is structured as an eighth oil path 198.

Further, as shown in FIG. 9, the region between the lower surface 34 of the hole 30 and the wide surfaces 44A, 44B of the magnets 40A, 40B that is exposed from between expanding materials 50B1, 50B2 is structured as a fifth oil path 186.

Moreover, holding frames 160A, 160B that are disposed at the side portions of the narrow surfaces 46A, 46B, 48A, 48B of the magnets 40A, 40B are shaped as rectangles that extend in the axial direction, respectively. Differently from the first embodiment, the grooves and the like are not formed therein.

The oil paths that are formed in the rotor core 14 of the motor 100 are described next.

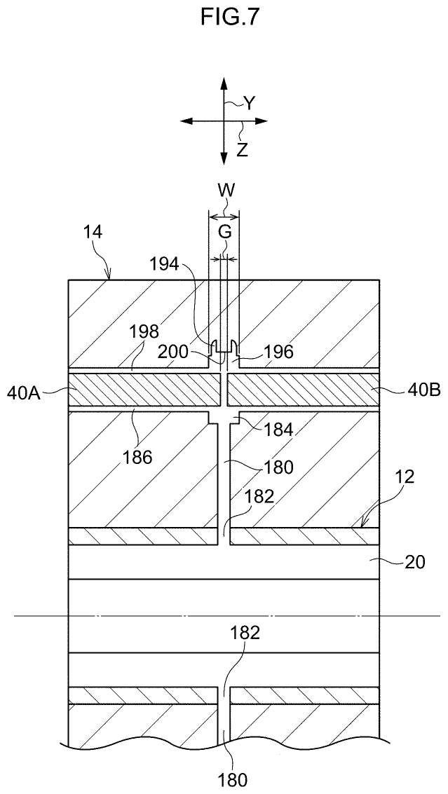

As shown in FIG. 6 and FIG. 7, the oil-cooling structure of the second embodiment has fourth oil paths 180 that extend from the oil reservoir 20 of the rotor shaft 12 toward the magnets 40A, 40B in a radial form, reservoirs 184 that are provided so as to face the axial direction ranges W of the magnets 40A, 40B and with which the radial direction outer side end portions of the fourth oil paths 180 communicate, and the fifth oil paths 186 (see FIG. 7) that extend in the axial direction from the reservoirs 184.

Note that the “fourth oil paths 180” correspond to the “first radial direction oil paths”. Further, the “fifth oil paths 186” correspond to the “cooling oil paths”.

The fourth oil paths 180 communicate with the oil reservoir 20 via holes 182 that are formed in the outer peripheral portion of the rotor shaft 12, and extend toward radial direction outer sides to as far as the wide surface 44A, 44B sides of the magnets 40A, 40B.

The radial direction outer side end portions of the fourth oil paths 180 communicate with the reservoirs 184 whose diameters are larger than those of the fourth oil paths 180.

The reservoirs 184 are provided so as to face the axial direction ranges W at the wide surfaces 44A, 44B of the magnets 40A, 40B.

Further, as shown in FIG. 7, the fifth oil paths 186, which extend in the axial direction from the reservoirs 184 and on the wide surfaces 44A, 44B of the magnets 40A, 40B, are formed. Namely, this is a structure in which the oil, which reaches the reservoirs 184 via the fourth oil paths 180 from the oil reservoir 20, goes through the fifth oil paths 186 and is discharged to the exterior of the rotor core 14.

Further, as shown in FIG. 6, eight sixth oil paths 190 that extend in a radial form toward the radial direction outer sides are formed between the eight fourth oil paths 180 that are formed in a radial form at the rotor core 14. One ends of the sixth oil paths 190 communicate with the oil reservoir 20 via holes 192 that are formed in the outer peripheral wall of the rotor shaft 12, and the other ends communicate with an octagonal seventh oil path 194 that circles around at the radial direction outer side of the eight magnets 40A, 40B.

Note that the “sixth oil paths 190” correspond to the “second radial direction oil paths”. Further, the “seventh oil path 194” corresponds to the “peripheral direction oil path”.

The seventh oil path 194 communicates with reservoirs 196 at the radial direction outer sides of the magnets 40A, 40B. The reservoirs 196 are formed so as to face the axial direction ranges W of the wide surfaces 42A, 42B of the magnets 40A, 40B.

Note that the reservoirs 196 correspond to the “second reservoirs”.

Further, as shown in FIG. 7, the eighth oil paths 198, which extend from the reservoirs 196 in the axial direction and on the wide surfaces 42A 42B, are formed. Namely, there is a structure in which the oil, which reaches the reservoirs 196 from the oil reservoir 20 via the sixth oil paths 190 and the seventh oil path 194, is discharged via the eighth oil paths 198 to the exterior of the rotor core 14.

Note that the “eighth oil paths 198” correspond to the “cooling oil paths”.

Further, as shown in FIG. 6, convex portions 200 that project-out toward the magnet 40A, 40B sides (the radial direction inner sides) are formed at the seventh oil path 194 at positions facing the reservoirs 196.

(Operation)

First, the expanding materials 50A1, 50A2, 50B1, 50B2 are interposed between the wide surfaces 42A, 42B of the magnets 40A, 40B and the upper surfaces 32, the lower surfaces 34 of the holes 30, and are disposed in the holes 30. Therefore, the magnets 40A, 40B are nipped by the expanding materials 50A1, 50A2, 50B1, 50B2 due to the expansion over time of the expanding materials 50A1, 50A2, 50B1, 50B2. Accordingly even if centrifugal force is applied to the magnets 40A, 40B by high speed rotation of the rotor core 14, the magnets 40A, 40B becoming offset within the holes 30 is prevented or suppressed.

Further, the holding frames 160A, 160B, which abut the narrow surfaces 46A, 46B, 48A, 48B of the magnets 40A, 40B and extend from the upper surfaces 32 to the lower surfaces 34 of the holes 30, are provided. These holding frames 160A, 160B extend from axial direction one end portions to the other end portions of the holes 30, and support the narrow surfaces 46A, 46B, 48A, 48B of the magnets 40A, 40B. Namely, offset of the magnets 40A, 40B in the width direction within the holes 30 due to high speed rotation of the rotor core 14 is prevented or suppressed.

In this way, the upper and lower sides of the magnets 40A, 40B, which are disposed so as to be lined-up in the axial direction within the holes 30, are held by the expanding materials 50A1, 50A2, 50B1, 50B2, and the left and right sides are held by the holding frames 60A, 60B. Due thereto, even if the rotor core 14 rotates at high speed, the magnets 40A, 40B do not become offset within the holes 30, and can be held reliably.

Further, due to the rotor core 14 rotating at high speed, the oil that is stored in the oil reservoir 20 of the rotor shaft 12 reaches the reservoirs 184 via the fourth oil paths 180 that extend toward the radial direction outer sides, due to the centrifugal force. Further, due to centrifugal force, the oil of the oil reservoir 20 goes through the sixth oil paths 190 that extend toward the radial direction outer sides and reaches the seventh oil path 194 that circles around, and is guided by the convex portions 200 that are provided at the seventh oil path 194 and reaches the reservoirs 196 at the radial direction inner side.

The axial direction end portions that face one another of the wide surfaces 42A, 42B of the magnets 40A, 40B are exposed to the reservoirs 196, and are efficiently cooled by the oil that reaches the reservoirs 196. Further, the axial direction end portions that face one another of the wide surfaces 44A, 44B of the magnets 40A, 40B are exposed to the reservoirs 184, and are efficiently cooled by the oil that reaches the reservoirs 184.

Moreover, the oil that reaches the reservoirs 196, 184 flows through the eighth oil paths 198 that are provided on the wide surfaces 42A, 42B of the magnets 40A, 40B, or through the fifth oil paths 186 that are provided on the wide surfaces 44A, 44B, and further cools the magnets 40A, 40B.

In particular, because the reservoirs 196, 184, the eighth oil paths 198 and the fifth oil paths 186 are respectively provided on the wide surfaces 42A, 42B and the wide surfaces 44A, 44B of the magnets 40A, 40B, the oil cools the magnets 40A, 40B directly, and the cooling efficiency improves more.

In the present embodiment, in order to supply oil on the wide surfaces 42A, 42B of the magnets 40A, 40B, at the rotor core 14, oil is supplied from the seventh oil path 194, which is positioned at the radial direction outer sides of the magnets 40A, 40B, to the reservoirs 196 that are at the radial direction inner sides. At this time, because the convex portions 200, which project-out toward the radial direction inner sides at those positions, are formed at the seventh oil path 194, even when the motor rotates, oil is supplied (guided) reliably from the seventh oil path 194 to the reservoirs 196 that are positioned at the radial direction inner side thereof, and the magnets 40A, 40B can be cooled.

(Effects)

In this way, at the motor 10, there is a structure in which the four surfaces of the rectangular magnets 40A, 40B are held within the holes 30 by the expanding materials 50A1, 50A2, 50B1, 50B2 and the holding frames 160A, 160B. Therefore, even if the rotor core 14 rotates at high speed, the magnets 40A, 40B becoming offset within the holes 30 is prevented or suppressed.

On the other hand, the wide surfaces 42A, 42B, 44A, 44B of the magnets 40A, 40B are cooled efficiently by the oil that flows through the reservoirs 196, 184, which are formed on the wide surfaces 42A, 42B, 44A, 44B, and the eighth oil paths 198 and the fifth oil paths 186. In particular, because the reservoirs 196, 184 are provided so as to face the axial direction ranges W of the wide surfaces 42A, 42B, 44A, 44B of the magnets 40A, 40B, the oil is stored at the axial direction end portions that face one another of the wide surfaces 42A, 42B, 44A, 44B, and the axial direction end portions that face one another of the magnets 40A, 40B, which become the hottest, can be cooled the most. Further, because the magnets 40A, 40B are cooled directly by the oil that is stored in the reservoirs 196, 184 and the oil that flows through the eighth oil paths 198 and the fifth oil paths 186, the cooling performance is even better.

Namely, the performance of cooling the magnets 40A, 40B can be improved while the ability to hold the magnets 40A, 40B of the motor 10 is ensured.

(Other Points)

The first and second embodiments describe that the expanding materials 50A, 50B, 50A1, 50A2, 50B1, 50B2 are a material that expands over time, but the present disclosure is not limited to this. For example, the expanding materials may be a material that thermally expands. Namely, when the temperatures of the magnets 40A, 40B rise due to the rotor core 14 rotating, the expanding materials may expand and reliably hold the magnets 40A, 40B.

In the first and second embodiments, the wide surfaces 42A, 42B, 44A, 44B of the magnets 40A, 40B are disposed within the rotor core 14 so as to be in the direction orthogonal to the radial direction, and the narrow surfaces 46A, 46B, 48A, 48B are disposed within the rotor core 14 so as to be in the radial direction. However, the directions in which these surfaces are disposed are not limited to these, and may be set arbitrarily. Namely, even in a case in which the directions in which the magnets 40A, 40B are placed are different than those of the first and second embodiments, there is no difference with regard to the points that the expanding materials are disposed between the holes 30 and the wide surfaces 42A, 42B, 44A, 44B, and the holding frames are disposed next to the narrow surfaces 46A, 46B, 48A, 48B, and the ability to hold the magnets 40A, 40B is ensured.

Moreover, although the holding frames 60A, 60B are made of resin in the first and second embodiments, the present disclosure is not limited to this.

In the first and second embodiments, there is a structure in which the two magnets 40A, 40B are disposed so as to be lined-up with respect to the hole 30, but three or more magnets may be lined-up. In this case, the axial direction range, which includes the gap that is formed between the magnets that are adjacent to one another in the axial direction, is set for each of the places where the magnets are adjacent to one another.

For example, in the first embodiment, if three magnets are disposed in the hole 30 so as to be lined-up in the axial direction, two axial direction ranges are respectively set, and concave portions at two places that correspond to these respective axial direction ranges are set with respect to the grooves 62A, 62B of the holding frames 60A, 60B.

Although embodiments have been described above, the present disclosure can be implemented in various forms within a scope that does not depart from the gist thereof.

An object of the present disclosure is to provide an oil-cooling structure for magnets of a motor and a motor in which the magnet cooling ability is improved while the ability to hold the magnets is ensured.

A first aspect is an oil-cooling structure for motor magnets, that includes: a rotor shaft; a rotor core mounted at an outer peripheral surface of the rotor shaft, which rotates integrally with the rotor shaft; a plurality of rectangular magnets arranged and aligned along an axial direction of the rotor shaft at interiors of holes for magnet placement that are formed in the rotor core and extend in the axial direction; a pair of expanding materials that are disposed between the holes and a pair of first surfaces, which extend in the axial direction, of the magnets disposed in the holes; a pair of holding frames that are disposed along the axial direction of the hole, adjacent to a pair of second surfaces, which extend in the axial direction of the rotor shaft, of the magnet; an oil reservoir formed at an interior of the rotor shaft, to which oil is supplied from an exterior; a pair of cooling oil paths that extend in the axial direction along sides, which are opposite from a side of the magnets, of the holding frames; radial direction oil paths formed so as to extend from the oil reservoir toward radial direction outer sides, and communicating the oil reservoir with the cooling oil paths; and grooves formed in the holding frames, recessed toward the side of the magnets at central regions in directions normal to the first surfaces at the holding frames, and extending in the axial direction.

In this oil-cooling structure for magnets of a motor, plural rectangular magnets are disposed so as to be lined-up in the axial direction with respect to the hole for magnet placement that is formed in the rotor core and extends in the axial direction. At this time, because the expanding materials are disposed between the (wall surfaces of) the hole and the pair of wide surfaces of the magnet that extend in the axial direction, the magnet is nipped within the hole by the expansion of the expanding materials. Namely, the magnets are reliably held without positional offset thereof arising due to rotation of the rotor core.

The holding frames are disposed adjacent to the narrow surfaces of the magnet that extend in the axial direction, and the magnet becoming offset within the hole is prevented or suppressed even more reliably.

In this way, the four surfaces of the rectangular magnet are fixed within the hole via the expanding materials and the holding frames. Therefore, the magnets are reliably held within the holes for magnet placement.

On the other hand, the cooling oil paths, which communicate via the radial direction oil paths with the oil reservoir formed in the interior of the rotor shaft, are formed in the rotor core along the axial direction at sides of the holding frames which sides are opposite the sides at which the magnets are located. Namely, the cooling oil paths are formed at positions such that the holding frames are disposed between the cooling oil paths and the narrow surfaces of the magnets. Accordingly, oil that was in the oil reservoir of the rotor shaft is supplied via the radial direction oil paths to the cooling oil paths of the rotor core by the centrifugal force that is due to the rotation of the rotor core, and the magnets are cooled efficiently.

Further, a groove, which extends in the axial direction and is recessed in toward the magnet side at the central region in the normal direction of the wide surface, is formed at the holding frame. Accordingly, the oil that has reached the cooling oil paths is guided by the interiors of the grooves of the holding frames. Namely, oil is guided to vicinities of the normal direction centers of the wide surfaces of the magnets where heat becomes confined at the rectangular magnets, and the cooling performance is excellent.

The “wide surfaces” or the first surfaces are first types of side surfaces of the rectangular magnet that extend in the axial direction, and the “narrow surfaces” or the second surfaces are second types of side surfaces of the rectangular magnet that extend in the axial direction. The lengths of the sides that are orthogonal to the axis direction of the “wide surfaces” are longer than the lengths of the sides that are orthogonal to the axis direction of the “narrow surfaces”.

A second aspect is the oil-cooling structure for motor magnets of the first aspect, wherein a concave portion, which is recessed further toward the side of the magnets than the groove of the holding frame, is formed in the groove across a range in the axial direction that includes a gap formed between the plurality of magnets that are adjacent to one another.

In this oil-cooling structure for magnets of a motor, the concave portion, which is recessed-in further toward the magnet side than the groove, is formed in the groove of the holding frame at an axial direction range that includes the gap formed between plural magnets that are adjacent to one another.

By the way, in a case in which plural magnets are disposed so as to be lined-up in the axial direction, magnetic flux is generated between the adjacent magnets, and the axial direction end portion of a magnet that is adjacent to another magnet becomes higher temperature than the other portions.

However, because the concave portion, which is recessed-in further toward the magnet side than the groove, is provided in the groove of the holding frame at a range in the axial direction that includes the gap formed between plural magnets that are adjacent to one another, the oil is stored in the concave portion, and the axial direction end portions, which face one another, of the plural magnets that are adjacent to one another in the axial direction are cooled more as compared with the other portions. Namely, because the performance of cooling the magnets by the oil is improved as compared with at other portions, the magnets are cooled more uniformly, and the cooling performance is excellent.

A third aspect is the oil-cooling structure for motor magnets of any of the first or second aspect, wherein a convex portion, which faces the groove and projects toward the side of the magnets, is formed at the cooling oil path at a surface an opposite side from the holding frame.

In this oil-cooling structure for magnets of a motor, at the cooling oil path, the convex portion, which faces the groove formed in the holding frame and which projects-out toward the magnet side, is formed in the surface that is at the side opposite the holding frame. Accordingly, the oil that reaches the cooling oil path from the oil reservoir is reliably guided to the groove of the holding frame by the convex portion, and the central portion, which becomes hottest, in the normal direction of the wide surface of the magnet can be cooled more efficiently.

A fourth aspect is an oil-cooling structure for motor magnets, that includes: a rotor shaft; a rotor core mounted at an outer peripheral surface of the rotor shaft, which rotates integrally with the rotor shaft; a plurality of rectangular magnets arranged and aligned along an axial direction of the rotor shaft at interiors of holes for magnet placement that are formed in the rotor core and extend in the axial direction; a pair of expanding materials that are disposed between the holes and a pair of first surfaces, which extend in the axial direction, of the magnets disposed in the holes; a pair of holding frames that are disposed along the axial direction of the hole, adjacent to a pair of second surfaces, which extend in the axial direction of the rotor shaft, of the magnet; an oil reservoir formed at an interior of the rotor shaft, to which oil is supplied from an exterior; first radial direction oil paths extending from the oil reservoir toward radial direction outer sides of the rotor core, and extending to the first surface sides that are at radial direction inner sides; second radial direction oil paths extending from the oil reservoir to further toward radial direction outer sides than the magnets of the rotor core; a peripheral direction oil path that, from outer side end portions of the second radial direction oil paths, circles around at radial direction outer sides of the magnets, and extends to the first surface sides that are at radial direction outer sides of the magnets; first reservoirs that communicate with the first radial direction oil paths, and are formed so as to face the first surfaces that are at the radial direction inner sides, across ranges in the axial direction that include gaps formed between the plurality of magnets that are adjacent to one another; second reservoirs that communicate with the peripheral direction oil path, and are formed so as to face the ranges in the axial direction at the first surfaces that are at the radial direction outer sides; and pairs of cooling oil paths formed so as to extend in the axial direction on the respective first surfaces from the first reservoirs and the second reservoirs to axial direction end portions of the rotor core.

In this oil-cooling structure for magnets of a motor, the plural rectangular magnets are disposed so as to be lined-up along the axial direction with respect to the hole for magnet placement that is formed in the rotor core and extends in the axial direction. At this time, because the expanding materials are disposed between the (wall surfaces of) the hole and the pair of wide surfaces of the magnet that extend in the axial direction, the magnet is nipped within the hole by the expansion of the expanding materials, and the magnets are reliably held without positional offset thereof arising due to rotation of the rotor core.

The holding frames are disposed adjacent to the narrow surfaces of the magnet that extend in the axial direction, and the magnet becoming offset within the hole is prevented or suppressed even more reliably.

In this way, the four surfaces of the rectangular magnet are fixed within the hole via the expanding materials and the holding frames. Therefore, the magnets are reliably held within the holes for magnet placement.

On the other hand, due to the centrifugal force that is due to rotation of the rotor core, the oil, which is supplied to the oil reservoir formed in the interior of the rotor shaft, reaches the first reservoirs, which are formed so as to face the wide surfaces that are at the radial direction inner sides of the magnets, via the first radial direction oil paths that extend toward the radial direction outer sides.

Further, due to the centrifugal force that is due to the rotation of the rotor core, the oil that has been supplied to the oil reservoir reaches the peripheral direction oil path via the second radial direction oil paths that extend toward the radial direction outer sides, and, via this peripheral direction oil path, reaches the second reservoirs that are formed so as to face the wide surfaces that are at the radial direction outer sides of the magnets.

The first reservoirs and the second reservoirs are formed so as to face the wide surfaces at axial direction ranges that include the gaps that are formed between plural magnets that are adjacent to one another. Therefore, oil is stored at the axial direction end portions that face one another at the wide surfaces of the magnets that are adjacent to one another in the axial direction. Namely, the oil directly cools the axial direction end portion sides that are the places where the temperature rises the most at the magnets, and the performance of cooling the magnets improves.

Further, because the cooling oil paths, which extend from the first reservoirs and the second reservoirs in the axial direction on the wide surfaces, are formed, the oil that reaches the first reservoirs and the second reservoirs flows through the cooling oil paths on the wide surfaces of the respective magnets from the one axial direction end portion side to the other axial direction end portion, and the cooling performance is even better.

A fifth aspect is the oil-cooling structure for motor magnets of the fourth aspect, wherein convex portions that project toward radial direction inner sides are formed at the peripheral direction oil path at regions facing the second reservoirs.

In this oil-cooling structure for magnets of a motor, the convex portion, which projects-out toward the radial direction inner side, is formed at the region of the peripheral direction oil path which region faces the second reservoir. Accordingly, the oil, which reaches the peripheral direction oil path from the oil reservoir via the second radial direction oil paths due to centrifugal force, is guided by the convex portion to the radial direction inner side of the peripheral direction oil path against the centrifugal force, i.e., is guided to the second reservoirs (the wide surface sides that are at the radial direction outer sides of the magnets). Accordingly, the magnet cooling performance is excellent.

A sixth aspect is a motor, that includes the oil-cooling structure for motor magnets of any of the first to third aspect. A seventh aspect is a motor that includes the oil-cooling structure for motor magnets of the fourth or fifth aspect.

Because this motor has the oil-cooling structure for magnets of a motor of any one of the first aspect through the fifth aspect, even if the plural magnets are disposed in the hole so as to be lined-up in the axial direction, the rectangular magnets can be reliably held within the holes for magnet placement, and the performance of cooling the magnets can be ensured.

As described above, in accordance with the oil-cooling structure for magnets of a motor and the motor of the present disclosure, the magnet cooling ability can be improved while the ability to hold the magnets is ensured.

What is claimed is:

1. An oil-cooling structure for motor magnets, comprising:
a rotor shaft;
a rotor core mounted at an outer peripheral surface of the rotor shaft, which rotates integrally with the rotor shaft;
a plurality of rectangular magnets arranged and aligned along an axial direction of the rotor shaft at interiors of holes for magnet placement that are formed in the rotor core and extend in the axial direction;
a pair of expanding materials that are disposed between the holes and a pair of first surfaces, which extend in the axial direction, of the magnets disposed in the holes;
a pair of holding frames that are disposed along the axial direction of the hole, adjacent to a pair of second surfaces, which extend in the axial direction of the rotor shaft, of the magnet;
an oil reservoir formed at an interior of the rotor shaft, to which oil is supplied from an exterior;
a pair of cooling oil paths that extend in the axial direction along sides, which are opposite from a side of the magnets, of the holding frames;
radial direction oil paths formed so as to extend from the oil reservoir toward radial direction outer sides, and communicating the oil reservoir with the cooling oil paths; and
grooves formed in the holding frames, recessed toward the side of the magnets at central regions in directions normal to the first surfaces at the holding frames, and extending in the axial direction.

2. The oil-cooling structure for motor magnets of claim 1, wherein:
first sides of the first surfaces and the second surfaces extend in the axial direction,
second sides of the first surfaces and the second surfaces are orthogonal to the axial direction, and
the second sides of the first surfaces are longer than the second sides of the second surfaces.

3. The oil-cooling structure for motor magnets of claim 1, wherein a concave portion, which is recessed further toward the side of the magnets than the groove of the holding frame, is formed in the groove across a range in the axial direction that includes a gap formed between the plurality of magnets that are adjacent to one another.

4. The oil-cooling structure for motor magnets of claim 1, wherein a convex portion, which faces the groove and projects toward the side of the magnets, is formed at the cooling oil path at a surface an opposite side from the holding frame.

5. An oil-cooling structure for motor magnets, comprising:
a rotor shaft;
a rotor core mounted at an outer peripheral surface of the rotor shaft, which rotates integrally with the rotor shaft;
a plurality of rectangular magnets arranged and aligned along an axial direction of the rotor shaft at interiors of holes for magnet placement that are formed in the rotor core and extend in the axial direction;
a pair of expanding materials that are disposed between the holes and a pair of first surfaces, which extend in the axial direction, of the magnets disposed in the holes;
a pair of holding frames that are disposed along the axial direction of the hole, adjacent to a pair of second surfaces, which extend in the axial direction of the rotor shaft, of the magnet;
an oil reservoir formed at an interior of the rotor shaft, to which oil is supplied from an exterior;
first radial direction oil paths extending from the oil reservoir toward radial direction outer sides of the rotor core, and extending to the first surface sides that are at radial direction inner sides;
second radial direction oil paths extending from the oil reservoir to further toward radial direction outer sides than the magnets of the rotor core;
a peripheral direction oil path that, from outer side end portions of the second radial direction oil paths, circles around at radial direction outer sides of the magnets, and extends to the first surface sides that are at radial direction outer sides of the magnets;
first reservoirs that communicate with the first radial direction oil paths, and are formed so as to face the first surfaces that are at the radial direction inner sides, across ranges in the axial direction that include gaps formed between the plurality of magnets that are adjacent to one another;
second reservoirs that communicate with the peripheral direction oil path, and are formed so as to face the ranges in the axial direction at the first surfaces that are at the radial direction outer sides; and
pairs of cooling oil paths formed so as to extend in the axial direction on the respective first surfaces from the first reservoirs and the second reservoirs to axial direction end portions of the rotor core.

6. The oil-cooling structure for motor magnets of claim 5, wherein:
first sides of the first surfaces and the second surfaces extend in the axial direction,
second sides of the first surfaces and the second surfaces are orthogonal to the axial direction, and
the second sides of the first surfaces are longer than the second sides of the second surfaces.

7. The oil-cooling structure for motor magnets of claim 5, wherein convex portions that project toward radial direction inner sides are formed at the peripheral direction oil path at regions facing the second reservoirs.

8. A motor, comprising the oil-cooling structure for motor magnets of claim 1.

9. A motor, comprising the oil-cooling structure for motor magnets of claim 5.
